(19) United States
(12) Patent Application Publication
(10) Pub. No.: US 2018/0137549 A1
(43) Pub. Date: May 17, 2018

(54) NON-REPUDIATION IN DRM

(71) Applicants: Dennis Vadura, Trabuco Canyon, CA (US); Wei Kang Tsai, Irvine, CA (US)

(72) Inventors: Dennis Vadura, Trabuco Canyon, CA (US); Wei Kang Tsai, Irvine, CA (US)

(73) Assignee: Badu Networks Inc.

(21) Appl. No.: 15/353,643

(22) Filed: Nov. 16, 2016

(51) Int. Cl. G06Q 30/06; G06Q 20/38

(52) U.S. Cl. CPC G06Q 30/0609; G06Q 50/184; G06Q 2220/00; G06Q 20/3829

(57) ABSTRACT

A system and method is provided for non-repudiated evidence that a copied digital item received by a buyer is sent by a specific and authorized distributor, and the copy is uncorrupted and legitimate for sale by the distributor. Non-repudiated evidence is generated based on unique encryption keys and hash codes identifying a specific distributor and a specific digital item. Credential checking is performed by a distribution system operator which is also responsible for collecting funds directly or indirectly. A potential buyer of a digital item is enabled to produce a digital object to send to the system operator to authenticate a received digital item. By checking the distributor's credential, the system operator authenticates the distributor and sends back a transaction ID and an encryption key. Once the buyer has purchased the digital item, the buyer can then be authorized to be a distributor of the digital item.

### CROSS REFERENCES TO RELATED APPLICATIONS

The present application claims priority to U.S. Provisional Patent Application No. 62/256,029 filed on Nov. 16, 2015, which is hereby incorporated by reference in its entirety.

### FIELD OF THE INVENTION

The present invention relates in general, to digital rights management (DRM), and more particularly, to non-repudiated evidence for selling a legitimate copy of digital object.

### BACKGROUND OF THE INVENTION

Today, all types of copyrighted digital media and content are marketed and sold through the Internet. Online distribution allows a seller to deliver copyrighted digital material into the hands of consumers with minimal overheads. This leads to lower prices for consumers and higher profits for sellers.

To prevent unauthorized copying and playing (consuming) digital media, often a system of digital rights management (DRM) is employed. A purpose of the DRM system is to prevent unauthorized executing, viewing, copying, printing, or altering a digital item.

Since it is easy to copy a digital item without error, one way to expand an online sales channel is to allow a consumer to resell a purchased digital item to his friends, family, or any interested party. This method creates an alternate distribution channel with minimal costs. In this method, a consumer of a digital item turns into a reseller or distributor of the same item.

Hereafter, a consumer-turned reseller will be referred to as a consumer-distributor or simply a distributor. Further, a distribution system employing consumer-distributors will be referred to as a consumer redistribution (CR) system.

In a CR system, the DRM has to perform a new task: verifying that a copy of a digital item received by a buyer is legitimate and uncorrupted, and the copy was sent from an authorized distributor. After verification, both the distributor and the copyright holder in a completed transaction can be compensated.

### BRIEF SUMMARY OF THE INVENTION

The present invention provides a means to generate non-repudiated evidence that a copied digital item received by a buyer is sent by a specific authorized distributor, and the copy is uncorrupted and legitimate for sale by the distributor. While the methods and systems disclosed are best suited for distribution systems based on the CR model, they are also applicable to general distribution systems selling digital objects.

In accordance with one aspect of the present invention, non-repudiated evidence is generated based on unique encryption keys and hash codes identifying a specific distributor and a specific digital item. Credential checking is performed by a distribution system operator which is also responsible for collecting funds directly or indirectly. A potential buyer of a digital item is enabled to produce a digital object to send to the system operator to authenticate a received digital item.

All embodiments of the present invention are described via a distributor, a buyer, a CR distribution system with a system operator, and a digital item. For simplicity, a CR distribution system with a system operator will be referred to as a system operator.

Technically, there are 5 verification issues involved in the non-repudiation problem:

(1) The seller has to verify that the system operator authorizes the sale;

(2) The buyer has to verify that the digital item he received is intact and not corrupt;

(3) The system operator has to verify that the seller is authorized;

(4) The system operator has to verify that the digital item received by the buyer is what the seller claims to sell to the buyer;

(5) The system operator has to verify that the digital item received by the buyer is authorized (legitimate) for sale.

In a CR distribution system, all distributors and all sellable digital items are individually identified by a unique identifier. Assuming that a distributor intends to sell a digital item, the distributor performs one of the following:

(1) generates a onetime encryption key to encrypt the digital item; or

(2) receives from the system operator a onetime encryption key to encrypt the digital item; or

(3) uses a previously received encrypted item for which the system operator has a decryption key.

If required, the distributor encrypts the digital item. The distributor then uses the encrypted item and generates a hash code to represent the encrypted digital item. The distributor then requests the system operator to approve selling the digital item, by sending the encryption key (if required), and the hash code to the system operator.

By checking the distributor's credential, the system operator authenticates the distributor and sends back a transaction ID and an asymmetric encryption key.

The distributor then splits the encrypted digital item into 2 segments. The first segment is encrypted using the asymmetric key provided by the system operator, while the second segment is not modified.

The distributor then prepares a private transaction package, which includes the transaction ID assigned by the system operator, and a doubly encrypted version of the digital item. (Strictly speaking, only a segment of the digital item is doubly encrypted, while the remaining segment is singly encrypted.) After the private transaction package is generated, it is provided to a buyer, either by direct sending or buyer-initiated download.

Upon receiving the private transaction package, the buyer extracts the transaction ID from the transaction package. The buyer sends the extracted transaction ID to the system operator. Then the system operator validates the buyer-sent transaction ID is valid by matching with a pending transaction ID stored in its database. After the validation, the system operator sends an asymmetric decryption key to the buyer. Using the asymmetric decryption key sent by the system operator, the buyer decrypts the doubly encrypted section of the digital item. The buyer then recovers an encrypted version of the digital item.

Next, the buyer generates a hash code using the recovered encrypted digital item. This hash code is then sent to the system operator for non-repudiated evidence that the buyer has received a legitimate and uncorrupted private transaction package from the distributor.

If the verification result is positive, then the system operator proceeds to consummate the transaction. Once the buyer has paid for the digital item, the system operator sends the onetime decryption key to the buyer to decrypt the encrypted digital item.

Once the buyer has purchased the digital item, the buyer can then be authorized by the system operator as a legitimate distributor of the digital item, thereby allowing further distribution.

In accordance with one aspect of the present invention, the non-repudiation methods and systems allow a generated private transaction package to be sent to a buyer via any means, including highly insecure means. The disclosed nonrepudiation method is expected to fail with an extremely low probability, even when the delivery environment is highly insecure.

### BRIEF DESCRIPTION OF THE DRAWINGS

The above and other objects and features in accordance with the present invention will become apparent from the following descriptions of embodiments in conjunction with the accompanying drawings, and in which:

FIG. 1 is an exemplary execution flow illustrating the steps carried out by the distributor, the buyer, and the system operator, according to the main method.

### DETAILED DESCRIPTION OF EXEMPLARY EMBODIMENTS

Systems and methods are described for producing non-repudiated evidence that a copied digital item is generated by a specific distributor and the copy is uncorrupted and authorized for sale by the distributor. The non-repudiated evidence allows a consumer, who has previously bought a digital item, to resell the same digital item to family, friends, or any interested party, thereby receiving a commission for the transaction. The systems and methods discourage pirating of the digital item, thereby increasing the revenue for the copyright holder.

While the present invention is intended for a distribution system based on the consumer redistribution (CR) model, it is also applicable to any distribution system selling digital objects. Hereafter, a CR system is meant to be any distribution system in which a distributor sends a copied digital item to a buyer, while the distribution system verifies authenticity of the sent digital copy and the identity of the distributor.

In all the embodiments of the present invention, an underlying CR distribution system is assumed. In the CR system, a digital item is a unit of packaged digital objects, properly formatted and stored in a computer system. A digital item can be a file, an image, a video, an audio, an e-book, a game, a data object, a web object, a computer program, or any other digital object. In addition, a digital item may also be a combination of files, web objects, images, audios, videos, e-books, games, data objects, or any other digital objects. Each digital item sold in the CR system is copyrighted with a copyright holder looking to sell the rights to consume (play or utilize) the digital item for an economic return. A distributor in the CR system is an entity that either owns the copyright to a digital item or has been granted the rights to resell or sell a digital item.

The CR system is equipped with a system operator, which is an entity that performs verifications, receiving payment, and disbursing funds, pertaining to selling a digital item from a distributor to a potential buyer. The system operator is the most important entity in the non-repudiation systems and methods—it has to protect the interest of 4 parties: the distributor, the buyer, the copyright holder (of the digital item), and the system itself.

For the distributor, the system operator is responsible for authorizing the distributor to sell the digital item, and verifying the copy sent by the distributor to be uncorrupted. For the buyer, the system operator is responsible for authenticating the copy sent by the distributor, and authorizing the transaction between the distributor and the buyer. For the copyright holder, the system operator is responsible for ensuring that the distributor sells the digital item to the buyer as claimed by the distributor. Finally, the system operator is also responsible for verifying that the buyer has received an uncorrupted copy of the digital item from the distributor.

After these verifications have produced a positive response, the system operator then proceed to consummate the transaction, compensate both the distributor and the copyright holder, and enable the buyer to consume the digital item.

Each of the 3 parties—the distributor, the system operator, and the buyer—is equipped with computing and communications resources for conducting online transactions. The computing and communications resources include at least one processor component, at least one memory component, and least one communications component to connect to the Internet.

To describe embodiments of the present invention, the following notations will be used. In a transaction, the distributor is denoted by D, and the system operator is denoted by S. The distributor D is assigned by the system operator S to a unique identifier DI. A buyer intending to purchase a digital item is denoted by C (consumer). The digital item that C intends to purchase from D is denoted by M. While the notation M seems to indicate that the digital item is a media file, there are no limitations as to the type of the digital item allowed for sale in the present invention. Hereafter, the terms “digital item,” “media item,” and “media file” are used interchangeably.

M is assigned by the system operator S to a unique identifier MI. The transaction of selling M from D to C is denoted by T. Let TI denote the unique transaction identifier assigned by S for the transaction T. Let P denote the private transaction package which D will allow C to receive for the transaction T. P will play a critical role in the embodiments.

In the present invention, it is assumed that D is an authorized distributor in good standing with S. It is assumed that S keeps a database of all authorized distributors, indexed by DIs, and a database of legitimate media files for sale, indexed by MIs.

In this disclosure, M is assumed to be unencrypted. However, in an embodiment, S may be the only party that has an unencrypted M, and D and C only receive encrypted versions of M. M is said to be legitimate if M is authentic and is allowed for sale through the CR system. An encrypted version of M is said to be legitimate if the unencrypted M is legitimate. The private transaction package P is said to be legitimate if C is allowed to purchase EM as delivered by P.

Without loss of generality, M is assumed to be either a digital file or a contiguous byte sequence (a continuous segment) of a digital file. It is further assumed that M is at least 1024 bytes in length. If M is shorter than 1024 bytes, then it will be padded to be 1024 bytes in a trivially obvious manner. It is also assumed that D knows the formats of DI, MI, and TI; C knows the format of TI. In one embodiment, DI, MI, and TI are UUIDs (universally unique IDs) owned and generated by system operator S.

Let Hash (X) denote the hash code generated for an arbitrary digital item X via a hash algorithm. Let Encrypt (K, X) denote the encrypted version EX (cipher text) of a digital item X, using an encryption key K. Let Decrypt (K, EX) denote the decrypted version (plain text) of a digital item EX, using the decryption key K. In this invention, the encryption algorithms used are selected by the implementor of S, D and C such that decrypting of a cipher text by a third party without the key K is computationally prohibitive.

Let <DK.Pub, DK.Priv> be a public-private key pair generated by S for D, where DK.Pub is the public key, which may be disclosed to any interested party, and DK.Priv is the private key, which is uniquely provided to D by S. Before the transaction is consummated, D allows C to receive EM, which is an encrypted copy of M. C relies on S to validate that the EM copy that it has received from D can be decrypted to produce an uncorrupted and authentic copy of M. The key pair <DK.Pub, DK.Priv> is used by S to verify that C has received a legitimate and uncorrupted copy of EM from D. In one embodiment, the pair <DK.Pub, DK.Priv> is dynamically generated (or updated) per transaction with D as the distributor.

To complete the transaction, S verifies C has received a legitimate and uncorrupted copy of EM from D. In one embodiment, S sends DK.Priv to D to enable D to encrypt a section of EM to send to C; in another embodiment, D keeps a copy of DK.Priv, which is used to encrypt a section of EM to send to C. S will send DK.Pub to C to enable C to decrypt a doubly encrypted section of EM. With this method, both D and C depend on S to complete the verifications needed for the transaction. This dependency makes it difficult for D and C to perform a private trade without paying royalty to the copyright holder of M. This is a key protection provided by the invention.

Let F.head (n) denote the initial n-byte continuous segment of a digital item F, and F.tail (n) denote the remaining segment of F after the initial n bytes are removed. As a convention, F.tail (−n) denotes the last n-byte continuous segment of F.

In the following, the main method of the present invention is described. Variations of the main method will be provided after the main method.

Operation by D:

D-1 Step:

D must produce EM, which is an encrypted version of M. If D does not have EM, it must obtain a key TK to encrypt M. In one embodiment D generates a onetime symmetric encryption key TK for the transaction T. In another embodiment D requests S to provide TK. Next, if D does not already have a suitable EM, D encrypts M with the symmetric key TK to generate EM, by the equation: EM=Encrypt (TK, M). Using a hash algorithm HA, D generates a hash code Y from EM by the equation: Y=Hash (EM). D sends <DI, MI, TK, Y> to S, requesting S to create a transaction indicating that D has intention to sell M.

Operation by S:

S-1 Step:

Upon receiving <DI, MI, TK, Y> from D, S verifies that: (1) D is an authorized distributor, (2) M identified by MI is an authorized item for sale in the CR system, and (3) D is allowed to sell a copy of M in the CR system. If any part of the 3-part verification fails, D is sent a failure code indicating a reason for the failure, and no further processing of the transaction occurs. If all parts verify successfully, S assigns TI to T, and computes a verification item M3 by the homomorphic sum, M3=M1+M2, over appropriate fields. In the sum, M1=Y, and M2=Hash (M), using the hash algorithm HA, which is also used by D and C. Optionally, S keeps a database of <MI, Hash (M)> for all M's for sale in the system. Optionally, the fields are GF2 fields (Galois fields of two elements) in a Paillier crypto-system.

The homomorphic sum, M3=M1+M2, is just one possible choice for a more general homomorphic algebra. Those skilled in the art will appreciate that other variations of the homomorphic algebra can be constructed. Further, the fields over which the homomorphic algebra is operated may also be non-GF2 fields.

S optionally generates a onetime key pair <DK.Priv, DK.Pub> for the pending transaction. S then records <TI, DI, MI, TK, M1, M2, M3, DK.Priv, DK.Pub> in its database and sends an approval notice with <TI, M3, DK.Priv> to D.

A brief description of the above multi-part verification is given. For (1), S keeps a database of authorized distributor IDs, and checks DI against the database to verify D as an authorized distributor. For (2), S keeps a database of authorized media file IDs, and checks MI agains the database to verify M as an authorized media file for sale. For (3), S keeps a database for each authorized distributor a list of authorized media file IDs for sale, and checks <DI, MI> against the database.

Operation by D:

D-2 Step:

Upon receiving the approval notice with <TI, M3, DK.Priv> from S, D constructs H, the header of the private transaction package P, by the equation: H=TI∥Z, where Z is a verification item, and the “∥” operator denotes digital concatenation of 2 or more binary sequences. H will be constructed to a fixed length of 1024 bytes. It is assumed that the length of the resulting concatenation, TI∥Z, is no larger than 1024 bytes. If the length of TI∥Z is strictly less than 1024 bytes, H is padded with zeros to make its length exactly 1024 bytes. Z is generated by the equation: Z=Encrypt (TK, M3).

D-3 Step:

Next, D splits EM into 2 parts, denoted by EM1 and EM2 by the equations: EM1=EM.head (N), EM2=EM.tail (N), where N is an integer parameter, equal to the size of EM1 in bytes, and 32<N<=1024. Next, D encrypts EM1 to generate EEM1, using DK.Priv as the encryption key, by the equation: EEM1=Encrypt (DK.Priv, EM1). Further, EEM1 is padded with zeros to reach an exact length of NN bytes, where NN>=N. It is assumed that C knows the value of NN. Next, D generates the private transaction package P by the equation: P=H∥EM2∥EEM1. Finally, D sends P to C, or allows C to get P, by any available means.

Operation by C:

C-1 Step:

Upon getting P from D, C extracts H from P. This is done unambiguously as C knows that H has a fixed length at 1024 bytes. C also extracts TI and Z from H, as C knows the format of TI and Z. Next, C sends the extracted TI to S to request DK.Pub from S.

Operation by S:

S-2 Step:

Upon receiving TI from C, S retrieves DK.Pub, using TI, from its database of approved pending transactions. If the received TI is matched with a stored TI from S's database, then S sends DK.Pub to C.

Operation by C:

C-2 Step:

Upon receiving DK.Pub from S, C generates C's copy of EM by the following steps. Let RP denote the remaining segment of P, after H is extracted: RP=P.tail (1024). Let RP_length denote the byte size of RP. Let EM1′ denote C's extracted copy of EM1, and EM2′ denote C's extracted copy of EM2. C constructs EM1′ by the equation: EM1′=Decrypt (DK.Pub, RP.tail (−NN)). C constructs EM2′ by the equation: EM2=RP.head (RP_length−NN). Next, C constructs C's copy of EM, denoted by EM′, by the equation: EM′=EM1′∥EM2′.

C-3 Step:

Using the hash algorithm HA, which is also used by D and S, C generates Y′, which is C's copy of the hash code Y, by the equation: Y′=Hash (EM′). C then sends <TI, Y′, EM1′, Z> to S to verify the private transaction package P obtained from D is legitimate and uncorrupted.

Operation by S:

S-3 Step:

Upon receiving <TI, Y′, Z> from C, S retrieves Y (=M1) and TK from its database using TI. S computes M3′ by the equation: M3′=Decrypt (TK, Z). Next, S computes M2′ by the equation: M2′=M3′−Y′. If M2′ fails to agree with M2, then S notifies C and D that the transaction cannot continue because C's copy of EM is corrupt. Otherwise, S further validates that EM (provided by D) is a valid encrypted copy of M by verifying that Decrypt (TK, EM1′) is a proper prefix (initial contiguous segment) of M. If the prefix check fails then S notifies C and D the transaction cannot continue because C's copy of EM is invalid. Otherwise, S validates that the EM′ recovered by C is uncorrupted by checking if Y (from D) is equal to Y′ (from C). If Y fails to agree with Y′, then the transaction cannot continue because C's copy of EM is different from D's copy.

Otherwise, S proceeds to consummate the transaction by requesting payment from C. After payment for the transaction has been collected from C, S sends TK to C to allow C to decrypt EM′. Further, S notifies D of the successful transaction and disburses compensation to D and to the copyright holder of M.

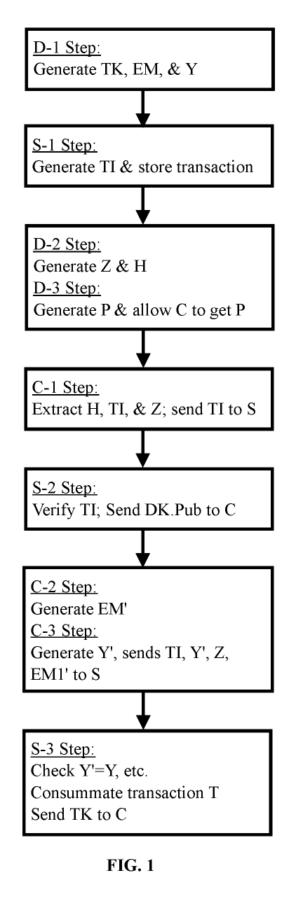

FIG. 1 illustrates the steps carried out by D, S, and C, as specified by the main method.

### Variations in Embodiments

Variations in D-1 Step:

In one embodiment, D generates a onetime random symmetric encryption key TK for the transaction T, using a seed based on Hash (MI), Hash (DK.Priv), a combination of both. The hash algorithm used for the hash codes is a choice for the implementer.

In one embodiment, D encrypts M with an asymmetric encryption key generated by S. In this embodiment, a different decryption key paired with the encryption key, is sent to C by S (in the S-3 Step) to enable to C to recover M.

Variations in S-1 Step:

In another embodiment, S generates a second key pair <DK2.Priv, DK2.Pub>. DK2.Priv will be sent to D for encrypting a portion of M before D provides P to C. After C has paid for the transaction, S then sends DK2.Pub to C allowing C to recover a full version of M from P.

Variations in D-2 Step:

The length of H can vary between 8 bytes up to 1024 bytes. In one embodiment, computation of Z and inclusion of Z in H are omitted.

Variations in D-3 Step:

The parameter N can vary between 8 up to 2048. Optionally, EM1 can be chosen to the second part of EM, while EM2 is chosen to be the first part: EM1=EM.tail (N), EM2=EM.head (N). In one embodiment, P=H∥EEM1∥EM2. In one embodiment, P is packaged as a vector: P=<H, EEM1, EM2>. If P is packaged as a vector, C is not assumed to know the value of NN, which is the length of EEM1.

Variations in C-3 Step:

In one embodiment, Z is omitted in the data sent from C to S for verification.

Variations in P:

In yet another embodiment, D sends EM1 to S, allowing S to encrypt EM1 using DK.Piv as the encryption key to produce EEM1, and S sending EEM1 to C. In this variation, D does not generate EEM1 and is not allowed to receive DK.Priv from S. In this variation, P generated by D is given by the equation P=H∥EM2. In this variation, S is in control of a larger portion of P, allowing a higher security in the transaction.

Variations in TI:

Distribution to multiple C's (buyers) with the same D and M may be also be allowed. To distribute to multiple C's, a single TI can be shared among different C's. Otherwise, a separate TI is used for each C buying a copy of M from D.

Mix and Match in Parts:

In some embodiments, different parts of the main method and the variations can be mixed and matched, to compose a new execution flow.

### SUMMARY OF NOTATIONS

D=the consumer distributor in the transaction

C=the buyer who buys from D

S=the system that implements the CR business model

M=the media item which D sells to C

T=the transaction of selling M from D to C

MI=identifier for M

DI=identifier for D

TI=identifier for T

DK.Priv=the private key of D

DK.Pub=the public key of D

EM=encrypted M, produced by D

EM1=the initial section of EM

EM2=the second and final section of EM

EM1′=C's copy of the first section of EM

EM2′=C's copy of the second and final section of EM

EEM1=encrypted EM1, produced by D

M1, M2, M3, M1′, M2′, M3′=various intermediate files in the homomorphic algebra

N=the length of EM1 in bytes, a parameter

NN=byte length of EEM1; NN>N

EM′=C's copy of EM

Y=hash code for EM, produced by D

TK=symmetric key created for T, produced by D

P=private transaction package to send to C, produced by D

H=header of P, produced by D

RP=remaining segment of P, or P with the header H stripped

RP_length=the length of RP in bytes

Z=a verification item produced by D

Y′=C's version of Y

“∥”=digital concatenation of 2 or more binary sequences

F.head (n)=initial n-byte segment of a digital item F

F.tail (n)=remaining segment of a digital item F after initial n bytes removed

F.tail (−n)=the last n-byte segment of F

Hash (X)=the hash code of X using a hash algorithm

Rationale for the design of the methods is described in the following. The hash code Y serves as an identifier for EM at the system operator. Using the homomorphic algebra, Y is used by S to compute M1, M2, and M3, for the purpose of verifying that C's recovered EM is an uncorrupted encrypted version of M.

The prefix check (S-3 Step) is a quick step to verify that an initial segment of M recoverable from P by C is uncorrupted.

Using the private transaction package P sent by D to C, C computes C's version of Y, which is Y′. C sends Y′ to the system operator S. S will compare Y against Y′ to determine if the private transaction package P received by C from D is legitimate and uncorrupted.

C uses the public key of D to recover EM1 from EEM1. Since EEM1 is a cipher text encrypted with the private key of D, it will serve as a digital signature of D on EM—if C can correctly decrypt EEM1 using the public key, then D should have created EEM1 with an extremely high probability.

The main method is designed so that, with an extremely high probability, M1′=M1 and Y′=Y only if C is able to reconstruct an uncorrupted and authentic copy of M from P.

The production of EEM1 is required—otherwise D could just share TK with C, and C could unpack and play M, without paying S. The private transaction package P is of no value to C unless C pays for M to S. Without paying, C cannot decrypt EM′ for personal consumption or reselling EM′ at a profit.

Non-Repudiation:

C cannot process P to get EM without cooperation from S: S can verify that EM′ is an uncorrupted encrypted version of an uncorrupted and authentic M. The 3-part verification done in S-3 Step will fail only with an extremely low probability, thereby achieving non-repudiation.

Variations in Distribution Method:

Once D produces P, any C can purchase M, resulting in compensation for D. There are numerous ways for D to make money by reselling through the CR system. Communications between C and D can be done totally outside the CR system. For example, D can post P to a third-party website, which may not be related to the CR system directly or indirectly. Any C purchases a copy of M from such a posting will result in compensation for D and royalty payment to the copyright holder of M.

Content Supply to the CR System:

The CR system should be supplied with legitimate data items for sale. As the current invention contemplates only non-repudiation issues, methods for validating copyright ownership are not described.

On the other hand, the disclosed nonrepudiation methods can be integrated with a digital watermark (or related technology) for checking authenticity of digital items sold through the CR system.

In the integrated method, an authentic copy of M within the CR system is embedded with a digital watermark to indicate authenticity. The watermark can be inserted by the system operator S, the copyright holder, or a third party. In the integrated method, D sends P or M to S for piracy check. If P is sent to S, S uses the received P to recover a copy of M. After S has obtained a copy of M (either by processing the received P from D or getting a copy of M directly from D), S extracts the watermark embedded in the copy of M. If the watermark is absent, or the extracted watermark is different from the authentic watermark, S deems that D's copy of M has been pirated.

If M fails the watermark test as indicated above, S can refuse to sell M, and ban the distributor D from future sales.

Applications in Industries:

Numerous industries can benefit from the nonrepudiation methods and systems disclosed in the present invention. In the following, applications in the film and music industries are briefly mentioned.

In the film industry, examples of D include: an independent theater, a TV station, a cable operator, a studio, a producer, an airline, a cruise liner company, an infotainment company, a private club, a religious organization, an individual, etc. Examples of M include: a movie, a sound track, a video clip, a documentary TV show, etc.

In the music industry, examples of D include: a musical ensemble, a composer, a recording company, a live music group an airline, a cruise liner company, an infotainment company, a private club, a religious organization, an individual, etc. Examples of M include: a recording, an album, an audio clip, etc.

What is claimed is:

1. A method for assuring authenticity of a seller and authenticity and integrity of a digital item to be sold in a transaction by the seller, with an operator, using computing devices over a communications network, comprising:
creating by the seller a new symmetric encryption key for a new transaction;
generating by the seller an encrypted digital item by encrypting the digital item by said symmetric encryption key;
generating by the seller a hash code from said encrypted digital item;
sending by the seller to the operator, said symmetric encryption key, said hash code, and a seller credential, and a digital-item credential to the operator;
authenticating by the operator the seller with the received seller credential;
authenticating by the operator the digital item with the received digital-item credential;
generating by the operator a public-private encryption-decryption key pair for a new transaction, comprising a public key and a corresponding private key;
generating by the operator a onetime transaction ID for the transaction;
sending by the operator said private key and said transaction ID to the seller;
storing by the operator said public key in its database.

2. A method for authenticating a digital item to be sold in a transaction from the seller to a buyer, with an operator, using computing devices over a communications network, comprising:
creating by the seller a new symmetric encryption key for a new transaction;
creating by the operator a public-private encryption-decryption key pair for a new transaction, comprising a public key and a corresponding private key;
sending by the operator to the seller said private key;
storing by the operator said public key in its database;
generating by the seller an encrypted digital item by encrypting the digital item by said symmetric encryption key;
splitting by the seller said encrypted digital item into 2 contiguous digital segments, comprising a first segment and a second segment;
encrypting by the seller said first segment with said private key to generate a doubly encrypted version of said first segment;
generating by the seller a private transaction package including at least the doubly encrypted version of said first segment, and said second segment;
obtaining by the buyer said private transaction package from the seller;
sending by the operator said public key to the buyer;
decrypting by the buyer the doubly encrypted version of said first segment included in the private transaction package obtained from the seller, using the received said public key sent by the operator;
reconstructing by the buyer, using the transaction package received from the seller, a copy of said encrypted digital item;
generating by the buyer a buyer-generated hash code for said buyer-reconstructed encrypted digital item;
sending by the buyer at least said buyer-reconstructed hash code to the operator for authenticating the encrypted digital item produced by the seller.

3. A method for authenticating a digital item to be sold in a transaction from the seller to a buyer, with an operator, using computing devices over a communications network, comprising:
creating by the operator a public-private encryption-decryption key pair for a new transaction, comprising a public key and a corresponding private key;
sending by the operator to the seller said private key;
storing by the operator said public key in its database;
generating by the seller an encrypted digital item by encrypting the digital item by a symmetric encryption key;
generating by the seller a hash code for said encrypted digital item;
sending by the seller said hash code for said encrypted digital item to the operator;
generating by the operator a hash code for a copy of the digital item stored in the database of the operator;
generating by the operator a verification item, using homomorphic algebra over some fields, from the hash code for said encrypted digital item received from the seller, and said operator-generated dash;
sending by the operator said verification item to the seller;
generating by the seller an encrypted verification item by encrypting the verification item received from the operator;
generating by the seller a private transaction package including at least the encrypted verification item produced by the seller;
obtaining by the buyer the encrypted verification item from the seller through a transaction package produced by the seller;
generating by the buyer a buyer-generated hash code based on the transaction package obtained from the seller;
sending by the buyer to the operator the encrypted verification item and a buyer-generated hash code for said encrypted digital item;
determining by the operator, based on a homomorphic algebra, using the encrypted verification item and the buyer-generated hash code, all received from the buyer, that the digital item for which the distributor intends to sell is authentic and uncorrupted.
